(19) United States
(12) Patent Application Publication
(10) Pub. No.: US 2010/0061657 A1
(43) Pub. Date: Mar. 11, 2010

(54) METHOD AND DEVICE FOR STABILIZING IMAGE AND METHOD FOR TRANSMITTING AND RECEIVING IMAGE USING THE SAME

(75) Inventor: Yen-Lung Chien, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/489,448

(22) Filed: Jun. 23, 2009

(30) Foreign Application Priority Data
Sep. 5, 2008 (TW) 97134210

(51) Int. Cl. G06K 9/36

(52) U.S. Cl. 382/276

(57) ABSTRACT

A method and a device for stabilizing an image, a method for transmitting and receiving the image using the same are provided. In the method for stabilizing the image, a face detection step is performed on the image first to obtain a face area in the image. Then, the size and position of the face area are stabilized, and thus the problem that the face shakes in the image is solved.

### CROSS-REFERENCE TO RELATED APPLICATION

This application claims the priority benefit of Taiwan application serial no. 97134210, filed on Sep. 5, 2008. The entirety of the above-mentioned patent application is hereby incorporated by reference herein and made a part of specification.

### BACKGROUND OF THE INVENTION

1. Field of the Invention

The invention relates to a method and a device for stabilizing an image, and a method for transmitting and receiving the image using the same and, more particularly, to a method and a device for stabilizing the image using face detection technique, and the method for transmitting and receiving the image using the same.

2. Description of the Related Art

With the combination of communication technique and network technique, visual communication gradually becomes a value-added function of a mobile phone and a trend of communication. Both communicators may transmit images between each other just by enabling the visual communication function of mobile phones. Then they not only can hear the voice of the other side, but also can see the image of the other side in real time during the visual communication. It is very convenient for busy modern people to communicate with their families or friends far away from them, and it also shortens the distance between each other virtually.

Generally, during the visual communication, the user may aim the camera at his face when he or she takes pictures. However, since the user always takes the mobile phone in his hand, the image may shake during taking pictures. The problem also exists in other handheld devices having video function, vehicle video cameras and other electronic products. The conventional method for solving the problem is shown in FIG. 1.

FIG. 1 is a schematic diagram showing an image stabilizing device and the coupling mode thereof. As shown in FIG. 1, the element denoted by 104 is the image stabilizing device, which includes a motion estimation unit 106 and an image stabilization unit 108. The motion estimation unit 106 is used to receive a dynamic image captured by the video unit 102 and estimate the motion vector of the image. The image stabilization unit 108 may select an area having a minimum motion vector from the whole image or a plurality of areas having smaller motion vectors to be a stabilizing object and stabilize the size and position of the selected area. Other areas which are not selected are adjusted reversely according to the estimating result of the motion vector to obtain a stabilized image output.

During the visual communication, both communicators want to see the other side's face. Since in the conventional technique, the face area in the image is not specially stabilized when the face is photographed, the face shakes in the image. Thus, the image after stabilized is still not the image wanted by the communicators.

### BRIEF SUMMARY OF THE INVENTION

One objective of the invention is to provide a method for stabilizing a face area in an image to solve the problem that the face shakes in the image.

Another objective of the invention is to provide an image stabilizing device which may stabilize a face area in an image to solve the problem that the face shakes in the image.

Still another objective of the invention is to provide a method for transmitting an image which may stabilize a face area in a transmitted image to solve the problem that the face shakes in the image.

The fourth objective of the invention is to provide a method for receiving an image which may stabilize a face area in a received image to solve the problem that the face shakes in the image.

Based on the above and other objectives, the invention provides a method for stabilizing an image. In the method, a face detection step is performed on the image first to obtain a face area in the image. Then, the size and position of the face area are stabilized.

Based on the above and other objectives, the invention provides an image stabilizing device including a face detecting unit and an image stabilization unit. The face detecting unit is used to perform a face detection step on an image to obtain a face area in the image. The image stabilization unit is used to stabilize the size and position of the face area.

Based on the above and other objectives, the invention provides a method for transmitting the image. In the image, a face detection step is performed on the image first to obtain a face area in the image. Then, the size and position of the face area are stabilized, and the image in which the face area is stabilized is compressed and transmitted to a remote terminal.

Based on the above and other objectives, the invention provides a method for receiving an image. In the method, image compression data is received and decompressed first to obtain an image. Then, a face detection step is performed on the image to obtain a face area in the image. Afterwards, the size and position of the face area are stabilized to obtain a displayed image.

According to the method for stabilizing the image in an embodiment of the invention, the method further includes estimating a motion vector of the image and adjusting other areas in the image except the face area according to an estimating result of the motion vector.

According to the image stabilizing device in an embodiment of the invention, the device further includes a motion estimation unit for estimating the motion vector of the image to output the estimating result of the motion vector to the image stabilization unit and adjust the other areas in the image except the face area.

According to the method for transmitting the image in an embodiment of the invention, before the image in which the face area is stabilized is compressed, the method further includes estimating the motion vector of the image and adjusting the other areas in the image except the face area according to the estimating result of the motion vector.

According to the method for receiving the image in an embodiment of the invention, when the size and the position of the face area are stabilized, the method further includes estimating the motion vector of the image and adjusting the other areas in the image except the face area according to the estimating result of the motion vector to obtain a displayed image.

In the invention, the face detection step in the image is performed to obtain a face area in the image, and then the size and the position of the face area are stabilized. Thus, the face area in the image is stabilized, and the problem that the face shakes in the image is solved. Besides, if a preferable image needs to be obtained, the motion vector of the image may be estimated, and the other areas in the image except the face area may be adjusted according to the estimating result of the motion vector.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a conventional image stabilizing device and the coupling mode thereof;

FIG. 2 is a schematic diagram showing the image stabilizing device and the coupling mode thereof according to an embodiment of the invention;

FIG. 3 is a flow chart showing a method for stabilizing a image according to an embodiment of the invention;

FIG. 4 is a flow chart showing a method for transmitting a image according to an embodiment of the invention; and

FIG. 5 is a flow chart showing a method for receiving a image according to an embodiment of the invention.

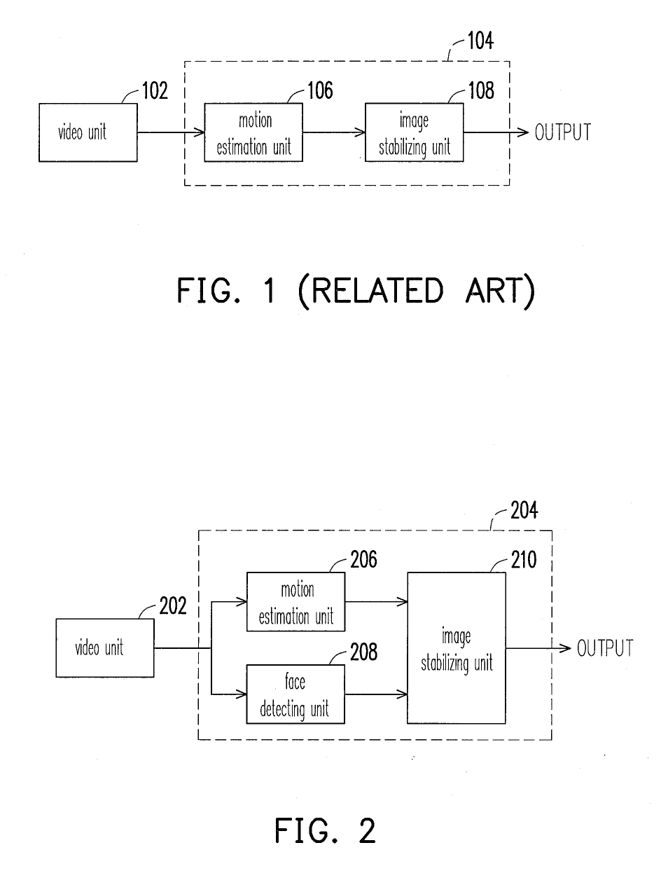

### DETAILED DESCRIPTION OF THE EMBODIMENTS

FIG. 2 is a schematic diagram showing an image stabilizing device and the coupling method in an embodiment of the invention. As shown in FIG. 2, the element denoted by 204 is the image stabilizing device, and it mainly includes a face detecting unit 208 and an image stabilization unit 210. In addition, it also includes a motion estimation unit 206. The face detecting unit 208 is used to perform a face detection step on a dynamic image captured by a video unit 202 to obtain a face area in the image. The motion estimation unit 206 is used to estimate the motion vector of the image to generate an estimating result of the motion vector. The image stabilization unit 210 is used to stabilize the size and position of the face area, adjust other areas in the image except the face area according to the estimating result of the motion vector and further obtain a stabilized image output.

In the embodiment, the mode in which the motion estimation unit 206 estimates the motion vector may be estimating a local motion vector and a global motion vector of the image or one of other feasible estimating modes, and the invention is not limited thereto. The mode in which the face detecting unit 208 performs the face detection step may be detecting facial features such as eyes, a nose, a mouse and other features to obtain the face area in the image, and it also may be detecting color features such as the colors of skin and hair and even may be detecting a vein, a shape and so on to obtain the face area, and it is also not limited.

To the image stabilization unit 210, the mode in which the position of the face area is stabilized may be stabilizing the face area at the original position in the image or any preset position in the image. However, in the application, of the visual communication, the optimal mode is stabilizing the face area at the center of the image. The mode in which the image stabilizing unit stabilizes the size of the face area may be stabilizing the face area to be the original size, stabilizing the size of the face area and the size of the whole image in a preset ratio, or stabilizing the size of the face area to a preset region. For example, in the visual communication, the user wants to see a face with a stable size and position, and therefore, the image stabilization unit 210 may be designed to stabilize the face area at the center of the image, and the size of the face area and the size of the whole image may be kept in the certain ratio. Thus, the face does not shake in the image. In other words, the image stabilization unit 210 may draw the moving face area back to the center of the image, and the size of the face area may be stabilized by zooming in/zooming out on the face area even the mobile phone shakes in the visual communication.

In addition, when the face detecting unit 208 performs the face detection step on the image to obtain a plurality of face areas, the image stabilization unit 210 may choose one of the face areas to be a stabilizing object. The other face areas are considered as backgrounds. The image stabilization unit 210 may choose a largest face area, a face area nearest to the center of the image, a face area in accordance with a preset face or a face area selected according to other preset criteria to be the stabilizing object.

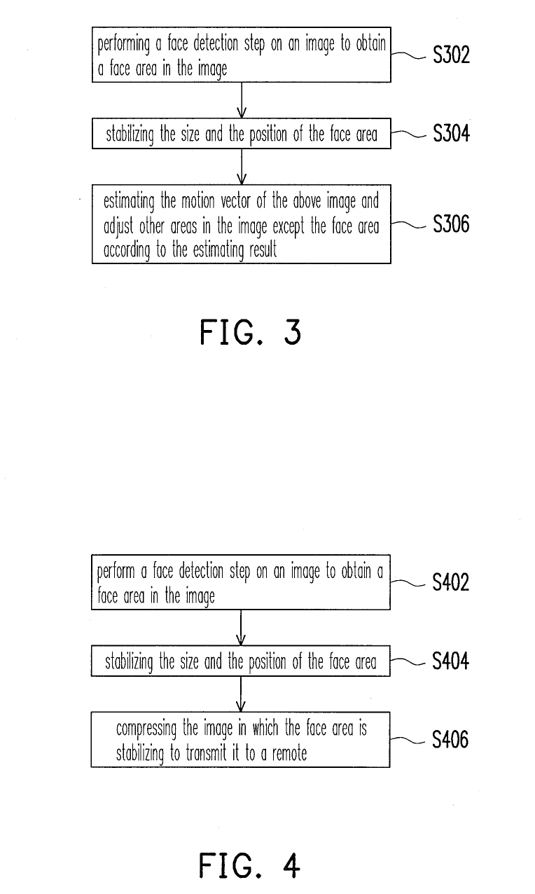

Some basic operation steps may be concluded via the above operation. FIG. 3 is a flow chart showing the method for stabilizing an image in an embodiment of the invention. As shown in FIG. 3, in the method, a face detection step is performed on an image first to obtain a face area in the image (as shown in step S302). Then, the size and position of the face area are stabilized (as shown in step S304). Thus, the face area in the image may be stabilized, and the problem that the face shakes in the image may be solved. If preferable image quality needs to be obtained, the motion vector of the image also may be estimated, and other areas in the image except the face area may be adjusted according to the estimating result of the motion vector (as shown in step S306).

If the captured image needs to be transmitted, the operation steps are shown in FIG. 4. FIG. 4 is a flow chart showing the method for transmitting the image in an embodiment of the invention. In the method, the face detection step is performed on a image first to obtain a face area in the image (as shown in step S402). Then, the size and position of the face area are stabilized (as in step S404). Afterwards, the image in which the face area is stabilized is compressed, and then it is transmitted to a remote terminal (as shown in step S406). Thus, the face area in the image is stabilized before the image is transmitted. This solves the problem that the face shakes in the image. If preferable quality of the image needs to be obtained, other areas in the image except the face area may be adjusted according to the estimating result of the motion vector before the image in which the face area is stabilized is compressed.

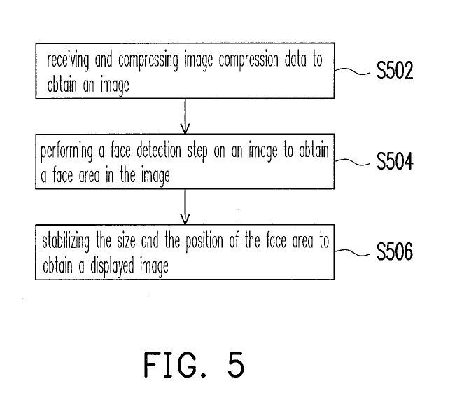

If the image captured by the other side is received, and if the other side does not have the function of stabilizing the face area of the image, the basic operation steps are shown in FIG. 5. FIG. 5 is a flow chart showing the method for receiving the image in an embodiment of the invention. In the invention, image compression data is received and decompressed to obtain an image (as shown in step S502). Then, the face detection step in the image is performed to obtain a face area in the image (as in step S504). Afterwards, the size and position of the face area are stabilized to obtain a displayed image (as in step S506). Thus, the face area in the image is stabilized after the image transmitted by the other side is obtained to solve the problem that the face shakes in the image. Then, the image is displayed. If preferable image quality needs to be obtained, when the size and position of the face area are stabilized, the motion vector of the image may be estimated, and other areas in the image except the face area are adjusted according to the estimating result of the motion vector to obtain the displayed image.

To sum up, in the invention, the face detection step is performed on the image to obtain a face area in the image, and then the size and position of the face area are stabilized to stabilize the face area in the image. Thus, the problem that the face shakes in the image is solved. Besides, if the motion vector of the image is estimated, and other areas in the image except the face area are adjusted according to the estimating result of the motion vector, preferable image quality may be obtained. Besides the mobile phone, handheld devices having video function and vehicle camera and other electronic devices, the invention also may be used in other related areas in which images need to be transmitted in real time.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for stabilizing an image, comprising:
performing a face detection step to obtain a face area in the image; and
stabilizing the size and the position of the face area.

2. The method for stabilizing the image according to claim 1, further comprises estimating a motion vector of the image and adjusting other areas in the image except the face area according to an estimating result of the motion vector.

3. The method for stabilizing the image according to claim 2, wherein the mode of estimating the motion vector comprises estimating a local motion vector and a global motion vector of the image.

4. The method for stabilizing the image according to claim 1, wherein when the face detection step is performed on the image and a plurality of face areas are obtained, one of the face areas is selected to be a stabilizing object, and the other face areas are considered as backgrounds.

5. The method for stabilizing the image according to claim 4, wherein a largest face area, a face area nearest to the center of the image or a face area in accordance with a preset face is selected to be the stabilizing object.

6. The method for stabilizing the image according to claim 1, wherein the mode of stabilizing the position of the face area comprises stabilizing the position of the face area at the center of the image.

7. The method for stabilizing the image according to claim 1, wherein the mode of stabilizing the size of the face area comprises stabilizing the size of the face area and the size of the whole image in a preset ratio.

8. The method for stabilizing the image according to claim 1, wherein the mode of stabilizing the face area comprises stabilizing the size of the face area to a preset region.

9. An image stabilizing device comprising:
a face detecting unit for performing a face detection step on an image to obtain a face area in the image; and
an image stabilization unit for stabilizing the size and the position of the face area.

10. The image stabilizing device according to claim 9, further comprising:
a motion estimation unit for estimating a motion vector of the image to output the estimating result of the motion vector to the image stabilization unit and allow the image stabilization unit to adjust other areas in the image except the face area.

11. The image stabilizing device according to claim 10, wherein the mode in which the motion estimation unit estimates the motion vector comprises estimating a local motion vector and a global motion vector of the image.

12. The image stabilizing device according to claim 9, wherein when the face detecting unit performs the face detection step on the image and obtains a plurality of face areas; the image stabilization unit further selects one of the face areas to be a stabilizing object, and other face areas are considered as backgrounds.

13. The image stabilizing device according to claim 12, wherein the image stabilization unit selects a largest face area, a face area nearest to the center of the image or a face area in accordance with a preset face to be the stabilizing object.

14. The image stabilizing device according to claim 9, wherein the mode in which the image stabilization unit stabilizes the face area comprises stabilizing the position of the face area at the center of the image.

15. The image stabilizing device according to claim 9, wherein the mode in which the image stabilizing unit stabilizes the size of the face area comprises stabilizing the size of the face area and the size of the whole image in a preset ratio.

16. The image stabilizing device according to claim 9, wherein the mode in which the image stabilizing unit stabilizes the size of the face area comprises stabilizing the size of the face area to a preset region.

17. A method for transmitting an image, comprising:
performing a face detection step to obtain a face area in the image;
stabilizing the size and the position of the face area; and
compressing the image in which the face area is stabilized to transmit the image to a remote terminal.

18. The method for transmitting the image according to claim 17, wherein before the step of compressing the image in which the face area is stabilized, the method further comprises estimating a motion vector of the image and adjusting other areas in the image except the face area according to an estimating result of the motion vector.

19. A method for receiving a image, comprising:
receiving and decompressing image compression data to obtain a image;
performing a face detection step on the image to obtain a face area in the image; and
stabilizing the size and the position of the face area to obtain a displayed image.

20. The method for receiving the image according to claim 19, wherein when the step of stabilizing the size and the position of the face area is performed, the method further comprises estimating a motion vector of the image and adjusting other areas in the image except the face area according to the estimating result of the motion vector to obtain the displayed image.
